(19) United States
(12) Patent Application Publication
(10) Pub. No.: US 2021/0162847 A1
(43) Pub. Date: Jun. 3, 2021

(54) Padded Multi-Piece Vehicle Cover Apparatus

(71) Applicant: Melvin McCanton, Fountain, CO (US)

(72) Inventor: Melvin McCanton, Fountain, CO (US)

(21) Appl. No.: 16/701,759

(22) Filed: Dec. 3, 2019

(51) Int. Cl. B60J 11/04

(52) U.S. Cl. CPC B60J 11/04

(57) ABSTRACT

A padded multi-piece vehicle cover apparatus for protecting a vehicle from hail includes a set of cover panels each having an inner layer, an outer layer, and a thick foam medial layer. The set of cover panels comprises a pair of rectangular central panels and a pair of side panels. The pair of vehicle profile-shaped side panels comprises a right side panel and a left side panel configured to extend across a vehicle right side and a vehicle left side of the vehicle, respectively. A set of zippers comprises a center zipper coupled between the pair of central panels, a right zipper coupled between the right center panel and the right side panel, and a left zipper coupled between the left center panel and the left side panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to vehicle covers and more particularly pertains to a new vehicle cover for protecting a vehicle from hail.

### BRIEF SUMMARY OF THE INVENTION

An embodiment of the disclosure meets the needs presented above by generally comprising a set of cover panels. Each of the set of cover panels has an inner layer, an outer layer, and a medial layer continuously disposed between the inner layer and the outer layer. The set of cover panels comprises a pair of central panels and a pair of side panels. The pair of central panels comprises a right center panel and a left center panel. The pair of central panels is configured to extend from a rear bumper end of a vehicle, over a vehicle top side, to a front bumper end of the vehicle. Each of the central panels is rectangular. The pair of side panels comprises a right side panel and a left side panel configured to extend across a vehicle right side and a vehicle left side of the vehicle, respectively. Each of the side panels has a vehicle profile shape. A set of zippers is coupled to the set of cover panels and comprises a center zipper coupled between the pair of central panels, a right zipper coupled between the right center panel and the right side panel, and a left zipper coupled between the left center panel and the left side panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a padded multi-piece vehicle cover apparatus according to an embodiment of the disclosure.

FIG. 2 is a side elevation view of an embodiment of the disclosure.

FIG. 3 is a rear elevation view of an embodiment of the disclosure.

FIG. 4 is a top plan view of an embodiment of the disclosure.

FIG. 5 is a cross-sectional view of an embodiment of the disclosure.

### DETAILED DESCRIPTION OF THE INVENTION

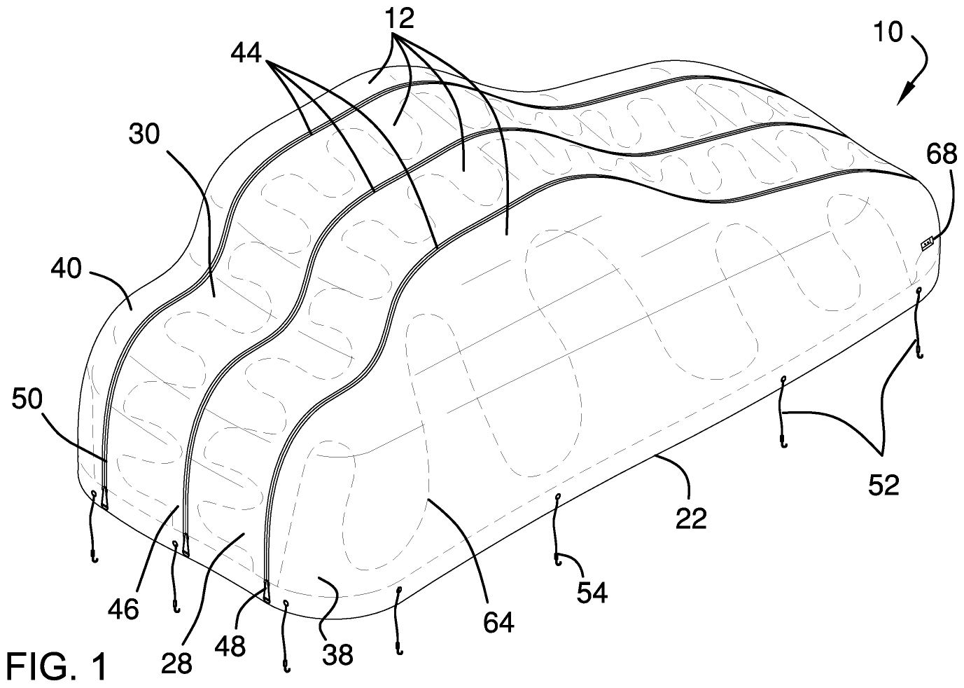

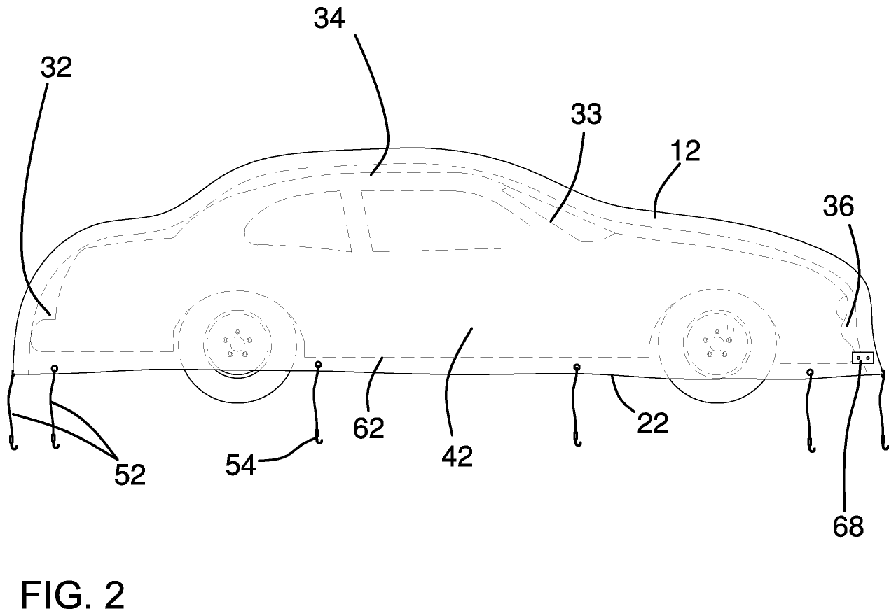

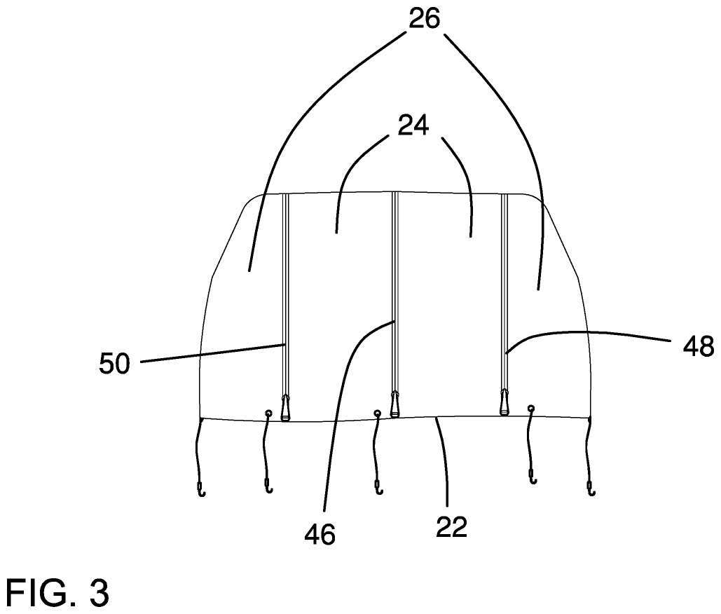

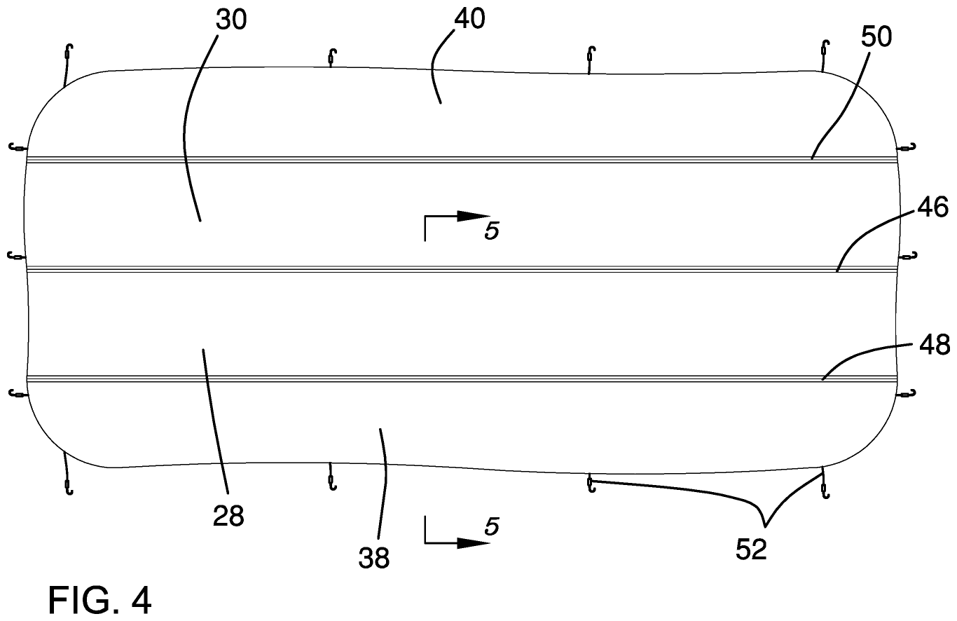

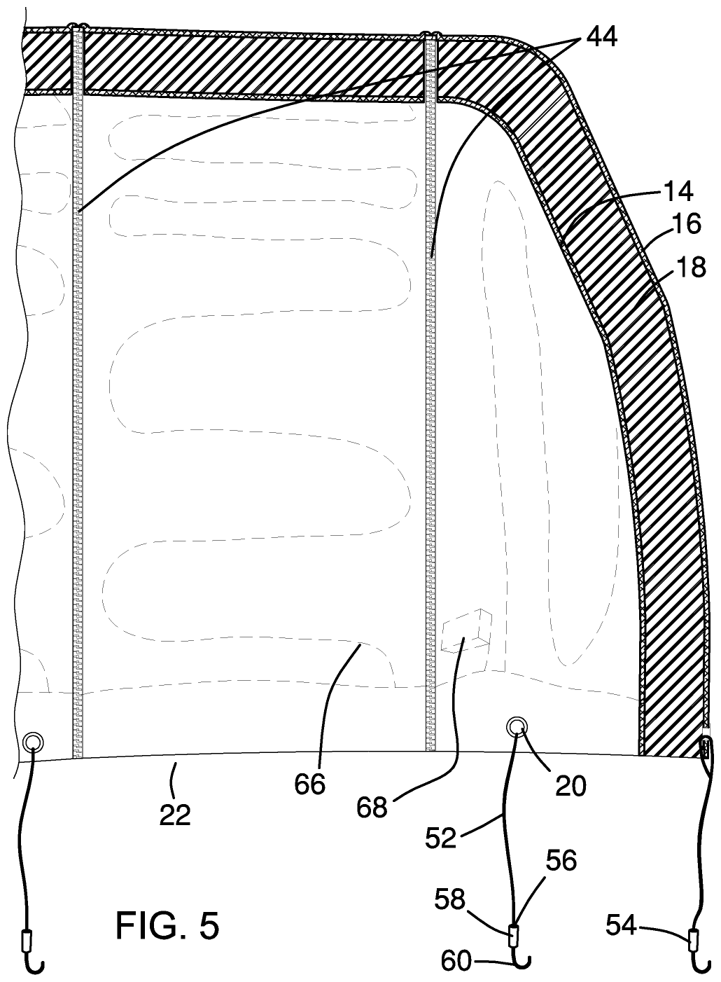

With reference now to the drawings, and in particular to FIGS. 1 through 5 thereof, a new vehicle cover embodying the principles and concepts of an embodiment of the disclosure and generally designated by the reference numeral 10 will be described.

As best illustrated in FIGS. 1 through 5, the padded multi-piece vehicle cover apparatus 10 generally comprises a set of cover panels 12 each having an inner layer 14, an outer layer 16, and a medial layer 18 continuously disposed between the inner layer 14 and the outer layer 16. The inner layer 14 is a felt material, the medial layer 18 is a foam padding, and the outer layer 16 is a weatherproof canvas material. The canvas may be at least 10.1 ounce weight and the foam padding may be a type No. CV40155 foam between 6.3 to 7.7 centimeters thickness. The medial layer 18 is at least eight times the thickness of the inner layer 14 and the outer layer 16. Each of the cover panels 12 has a plurality of grommeted apertures 20 extending therethrough adjacent a bottom perimeter 22.

The set of cover panels 12 comprises a pair of central panels 24 and a pair of side panels 26. The pair of central panels 24 comprises a right center panel 28 and a left center panel 30. The pair of central panels 24 is configured to extend from a rear bumper end 32 of a vehicle 33, over a vehicle top side 34, to a front bumper end 36 of the vehicle. Each of the central panels 24 is rectangular. The pair of side panels 26 comprises a right side panel 38 and a left side panel 40 configured to extend across a vehicle right side 42 and a vehicle left side of the vehicle, respectively. Each of the side panels 26 is a vehicle profile shape. A set of zippers 44 is coupled to the set of cover panels 12. The set of zippers 44 comprises a center zipper 46 coupled between the pair of central panels 24, a right zipper 48 coupled between the right center panel 28 and the right side panel 38, and a left zipper 50 is coupled between the left center panel 30 and the left side panel 40. The set of zippers 44 allows the set of cover panels 12 to separate and be rolled for easier storage.

A plurality of elastic straps 52 is coupled to the plurality of grommeted apertures 20. Each of the elastic straps 52 has a hook 54 coupled to a distal end 56 thereof. The hook 54 may have a cylindrical joining portion 58 and a hooked portion 60. The joining portion 58 is coupled to the distal end 56 and the hooked portion 60 is configured to attach to an undercarriage 62 of the vehicle. A heating element 64 is coupled to the set of cover panels 12. The heating element 64 has a heating coil 66 extending throughout each of the cover panels 12 and a power adaptor 68 coupled to the right side panel 38. The heating coil 66 is in operational communication with the power adaptor 68 and the power adaptor 68 is configured to receive a standard power cord.

In use, the set of cover panels 12 are joined with the set of zippers 44 and placed on to the vehicle 33. The hook 54 of each of the elastic straps 52 is then attached to the undercarriage 62 to maintain the apparatus 10 in place during high winds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A padded multi-piece vehicle cover apparatus comprising:
a set of cover panels, each of the set of cover panels having an inner layer, an outer layer, and a medial layer continuously disposed between the inner layer and the outer layer, the set of cover panels comprising:
a pair of central panels, the pair of central panels comprising a right center panel and a left center panel, the pair of central panels being configured to extend from a rear bumper end of a vehicle, over a vehicle top side, to a front bumper end of the vehicle, each of the central panels being rectangular; and
a pair of side panels, the pair of side panels comprising a right side panel and a left side panel configured to extend across a vehicle right side and a vehicle left side of the vehicle, respectively, each of the side panels having a vehicle profile shape; and
a set of zippers coupled to the set of cover panels, the set of zippers comprising a center zipper coupled between the pair of central panels, a right zipper coupled between the right center panel and the right side panel, and a left zipper coupled between the left center panel and the left side panel.

2. The padded multi-piece vehicle cover apparatus of claim 1 further comprising each of the cover panels having a plurality of grommeted apertures extending therethrough adjacent a bottom perimeter, the grommeted apertures being configured to receive a plurality of bungee cords.

3. The padded multi-piece vehicle cover apparatus of claim 2 further comprising a plurality of elastic straps coupled to the plurality of grommeted apertures, each of the elastic straps having a hook coupled to a distal end thereof, the hook being configured to attach to an undercarriage of the vehicle.

4. The padded multi-piece vehicle cover apparatus of claim 1 further comprising a heating element coupled to the set of cover panels, the heating element having a heating coil extending throughout each of the cover panels and a power adaptor coupled to the right side panel, the heating coil being in operational communication with the power adaptor and the power adaptor being configured to receive a standard power cord.

5. The padded multi-piece vehicle cover apparatus of claim 1 further comprising the inner layer being a felt material, the medial layer being a foam padding, and the outer layer being a weatherproof canvas material.

6. The padded multi-piece vehicle cover apparatus of claim 5 further comprising the canvas being at least 10.1 ounce weight.

7. The padded multi-piece vehicle cover apparatus of claim 5 further comprising the foam padding being a type No. CV40155 foam between 6.3 to 7.7 centimeters thickness.

8. The padded multi-piece vehicle cover apparatus of claim 1 further comprising the medial layer being at least eight times the thickness of the inner layer and the outer layer.

9. A padded multi-piece vehicle cover apparatus comprising:
a set of cover panels, each of the set of cover panels having an inner layer, an outer layer, and a medial layer continuously disposed between the inner layer and the outer layer, the inner layer being a felt material, the medial layer being a foam padding, and the outer layer being a weatherproof canvas material, the medial layer being at least eight times the thickness of the inner layer and the outer layer, each of the cover panels having a plurality of grommeted apertures extending therethrough adjacent a bottom perimeter; the set of cover panels comprising:
a pair of central panels, the pair of central panels comprising a right center panel and a left center panel, the pair of central panels being configured to extend from a rear bumper end of a vehicle, over a vehicle top side, to a front bumper end of the vehicle, each of the central panels being rectangular; and
a pair of side panels, the pair of side panels comprising a right side panel and a left side panel configured to extend across a vehicle right side and a vehicle left side of the vehicle, respectively, each of the side panels having a vehicle profile shape;
a set of zippers coupled to the set of cover panels, the set of zippers comprising a center zipper coupled between the pair of central panels, a right zipper coupled between the right center panel and the right side panel, and a left zipper coupled between the left center panel and the left side panel;
a plurality of elastic straps coupled to the plurality of grommeted apertures, each of the elastic straps having a hook coupled to a distal end thereof, the hook being configured to attach to an undercarriage of the vehicle; and
a heating element coupled to the set of cover panels, the heating element having a heating coil extending throughout each of the cover panels and a power adaptor coupled to the right side panel, the heating coil being in operational communication with the power adaptor and the power adaptor being configured to receive a standard power cord.
